(19) United States
(12) Patent Application Publication
(10) Pub. No.: US 2023/0061587 A1
(43) Pub. Date: Mar. 2, 2023

(54) AUTOMATED DETECTION AND ALERT OF MISCONFIGURED INDUSTRIAL AUTOMATION DEVICES

(71) Applicant: Claroty Ltd., Tel Aviv (IL)

(72) Inventor: Sharon Brizinov, Gan Yavne (IL)

(21) Appl. No.: 17/460,422

(22) Filed: Aug. 30, 2021

(51) Int. Cl. G05B 19/418

(52) U.S. Cl. CPC G05B 19/4185; G05B 19/41845; G05B 19/4188; G05B 19/4183

(57) ABSTRACT

A method for detecting misconfigured industrial automation devices within an operational technology (OT) network of programmable logic controllers (PLCs) and/or distributed control systems (DCSs), each PLC including one or more central processing unit (CPU) cards, one or more communication cards, and one or more input/out (I/O) cards, each I/O card controlling a machine or process in a physical network, the method including parsing a project file that includes information about a PLC and its configuration, and about the logic that runs on the PLC, generating a network layout configured in the project the, based on the results of the parsing, scanning the PLC including extracting information regarding the PLC configuration and the network layout, generating an actual network layout, based on the results of the scanning, and comparing the actual network layout with the network layout configured in the project file, to detect misconfigurations in the project file.

### FIELD OF THE INVENTION

The invention relates to an operational technology (OT) network of programmable logic controllers (PLCs) that control machines and/or processes.

### BACKGROUND OF THE INVENTION

An industrial automation process generally includes machines in a physical network that carry out processes, and a control network of PLCs that control the machines and processes. Specifically, industrial automation devices are controlled via an OT network of PLCs, each PLC including one or more central processing unit (CPU) cards, one or more communication (COMM) cards, and one or more input/out (I/O) cards, each I/O card controlling a machine or process in a physical network.

Reference is made to FIG. 1, which is a prior art illustration of a project file for a PLC, shown on an engineering station of ROCKWELL AUTOMATION®. FIG. 1 shows a series of logic files for performing various tasks, for a PLC for a chemical plant, one of which, named “Main”, is highlighted and includes the detailed logic shown in the “Logic Data” window. FIG. 1 also shows a PLC configuration including three PLC cards; namely, PLC Card #0, PLC Card #1 and PLC Card #2. PLC Card #2 is expanded to show that it includes a COMM card using a ControlNet Bus, with five (5) nested PLCs that sit on the ControlNet Bus. The PLC includes a network attribute; namely, an IP address, shown at the top of FIG. 1.

Industrial automation misconfigurations are very common within OT networks. Usually they go undetected for months or even years without anyone noticing them. There are many reasons why they occur, attributable to architectural complexity, lack of visibility, and human errors.

For example, when an engineer first configures a Rockwell Automation PLC, the engineer creates a project file (.ACD file) and configures the network layout in the project file so that the PLC may see and interact with other devices in its network. Later the engineer downloads the configuration to the PLC. However, with time the network layout changes, PLC parts are replaced, and the ground-truth for the PLC becomes false. In fact, different “truths” are discovered by (i) analyzing passive traffic, versus (ii) active querying of the device, versus (iii) a project file that the engineer believes is the latest updated version of the PLC.

Conventional tools for detecting misconfigurations, such as VERSIONDOG® manufactured by AUVESY GmbH of Landau, DE, MDT AUTOSAVE manufactured by MDT Software of Alpharetta, Ga., and FACTORYTALK® ASSETCENTRE manufactured by Rockwell Automation of Milwaukee, Wis., are focused on detecting changes in different versions of a project file itself. These tools request a project file from the PLC, and compare an old project file with a new one extracted from the PLC.

### SUMMARY

Embodiments of the present invention assume that the project file on the PLC may not be updated with the “reality”; i.e., that the configured network layout and the physical cards on the PLC may not be synchronized with the project file configured on the PLC.

Embodiments of the present invention provide a hybrid approach that combines both parsing of the configured project file with active scanning of the PLC and surrounding network devices, extracts information regarding the configuration and network layout, and compares the two.

There is thus provided in accordance with an embodiment of the present invention a method for detecting misconfigured industrial automation devices within an OT network of PLCs and/or distributed control systems (DCSs), each PLC including one or more CPU cards, one or more COMM cards, and one or more I/O cards, each I/O card controlling a machine or process in a physical network, the method including parsing a project file that includes information about a PLC and its configuration, and about the logic that runs on the PLC, generating a network layout configured in the project file, based on the results of the parsing, scanning the PLC including extracting information regarding the PLC configuration and the network layout, generating an actual network layout, based on the results of the scanning, and comparing the actual network layout with the network layout configured in the project file, to detect misconfigurations in the project file.

Additionally, the parsing includes assigning a parser to the project file, based on file type of the project file.

Further, the assigned parser extracts information about the types of cards in the PLC, a network identity of the PLC, a network layout configured in the PLC, and other device configurations in the OT network.

Yet further, the scanning includes generating an information request packet, in an appropriate industrial control system (ICS) protocol, for the PLC, and transmitting the information request packet to the PLC.

Moreover, the PLC, in response to receiving the information request packet, provides information about a PLC type, cards configured on the PLC, a network identity of the PLC, program logic currently being executed on the PLC, and other device configurations in the OT network.

Additionally, the scanning includes inferring bus types supported by the PLC, based on a communication card configured on the PLC.

Further, the scanning includes discovering one or more other PLCs communicatively coupled with the PLC via one or more respective communication cards configured on the PLC.

Yet further, the method includes generating suggestions as to what to correct in the project file and/or in the physical layout, based on the comparing.

Moreover, the method includes generating recommendations regarding additions to the PLC configuration or the PLC logic, for improving an automation process.

Additionally, the method includes generating an historical report of PLC configuration changes.

Further, the method includes generating a statistical report including one or more of (i) how frequently the PLC configuration is changed, (ii) the number of misconfigurations found in a specific period of time, and (iii) how many PLCs have similar attributes.

Yet further, the method includes generating a security report including which devices and configurations violate a desired security policy.

Moreover, the method includes generating recommendations regarding additions to the PLC configuration or the PLC logic, for improving network security controls.

### BRIEF DESCRIPTION OF THE DRAWINGS

The present invention will be more fully understood and appreciated from the following detailed description, taken in conjunction with the drawings in which:

FIG. 1 is a prior art illustration of a project file for a PLC, shown on an engineering station of Rockwell Automation;

FIG. 2 is a simplified diagram of a misconfigured PLC project file, detected by a system and method in accordance with an embodiment of the present invention.

FIG. 3 is a simplified block diagram of a system for detecting misconfigured industrial automation devices within an OT network of PLCs, in accordance with an embodiment of the present invention.

FIG. 4 is a simplified flowchart of a method for detecting misconfigured industrial automation devices within an OT network of PLCs.

For reference to the figures, the following index of elements and their numerals is provided. Similarly numbered elements represent elements of the same type, but they need not be identical elements.

| Type of element | Numeral |
|---|---|
| system for detecting misconfigured PLCs | 100 |
| host | 110 |
| router/switch | 120 |
| PLC | 130 |
| CPU card | 131 |
| communication card | 132 |
| I/O card | 133 |
| PLC analyzer | 200 |

Elements numbered in the 1000's are operations of flow charts.

### DETAILED DESCRIPTION

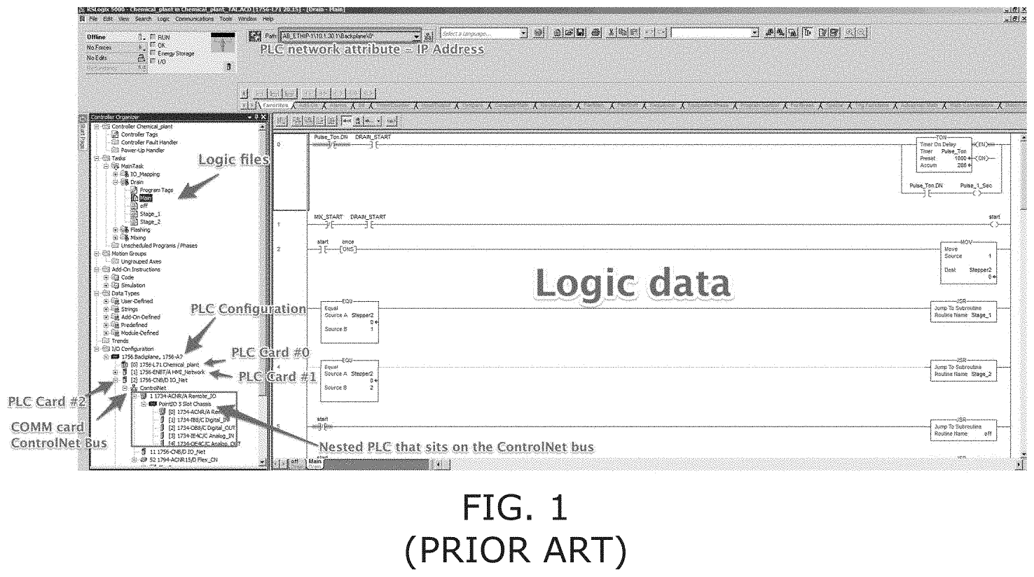

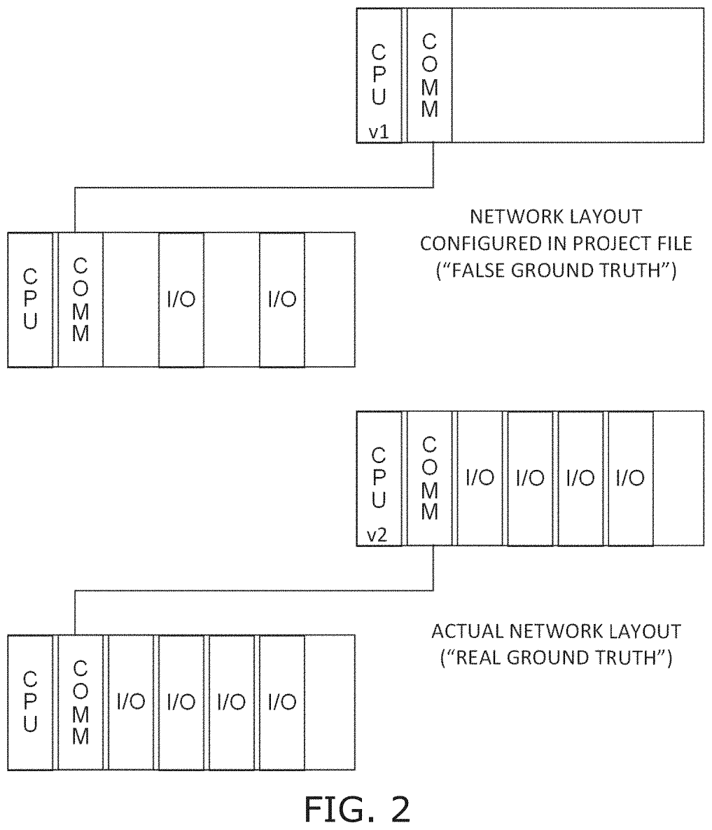

Reference is made to FIG. 2, which is a simplified diagram of a misconfigured PLC project file, detected by a system and method in accordance with an embodiment of the present invention. Shown in FIG. 2 is (i) a network layout as configured in a project file, such as the project file shown in FIG. 1, and (ii) an actual network layout. As may be seen, the network layout as configured in the project file is a “false ground truth”, and shows a PLC having a CPU card, a COMM card, and two I/O cards, with a nested PLC behind it that has a version 1 CPU card, a COMM card, and no I/O cards. The actual network layout is a “real ground truth”, and shows a PLC having a CPU card, a COMM card, and four I/O cards, with a nested PLC behind it that has a version 2 CPU card, a COMM card, and four I/O cards.

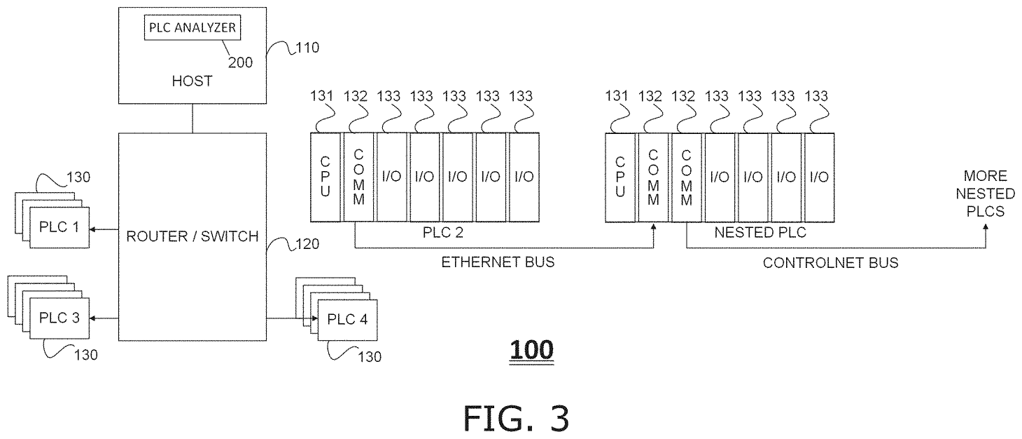

Reference is made to FIG. 3, which is a simplified block diagram of a system 100 for detecting misconfigured industrial automation devices within an OT network of PLCs, in accordance with an embodiment of the present invention. FIG. 3 shows a host computer 110, a router/switch 120, and a network of PLCs 130. PLC 2 is shown having a CPU card 131, an Ethernet bus COMM card 132, and five I/O cards 132. Behind PLC 2 is a nested PLC, connected to PLC2 via COMM card 132. The nested PLC has a CPU card 131, an Ethernet bus COMM card 132, a ControlNet bus COMM card 132, and four I/O cards 132. Additional PLCs are nested via ControlNet bus COMM card 132.

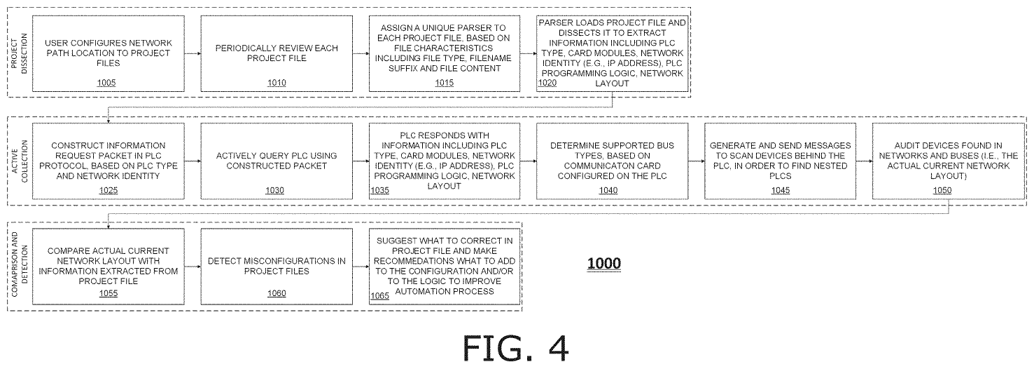

Host computer 110 includes a PLC analyzer 200, for detecting misconfigurations of the PLC network. Operation of PLC analyzer 200 is described below with reference to FIG. 4.

Reference is made to FIG. 4, which is a simplified flowchart of a method 1000 for detecting misconfigured industrial automation devices within an OT network of PLCs. Method 1000 employs three phases; namely, a project dissection phase, an active collection phase, and comparison and detection phase.

At operation 1005, a user configures a network path location to one or more project files for a PLC network, such as the IP address shown in FIG. 1. At operation 1010, PLC analyzer 200, shown in FIG. 3, periodically reviews each project file. At operation 1015, PLC analyzer 200 assigns a unique parser to each project file, based on file characteristics including file type, filename suffice and file content. A parser dissects project files based on their binary or text format in order to extract human-readable information. At operation 1020, each assigned parser loads its project file and dissects it to extract information including a PLC type, card modules, a network identity such as an IP address, PLC programming logic, and a network layout. Operations 1010-1020 constitute the project dissection phase of method 1000.

At operation 1025, PLC analyzer 200 constructs an information request packet using an appropriate PLC protocol, based on the PLC type and the network identity extracted at operation 1020. E.g., for a Siemens-based PLC, S7Comm or S7Comm+ protocols are used, and for a Rockwell Automation-based PLC, Ethernet/IP and CIP protocols are used to query the PLC. At operation 1030, PLC analyzer 200 actively queries the PLC using the information request packet constructed at operation 1025. At operation 1035, the PLC responds to PLC analyzer 200 with information including a PLC type, card modules, a network identity such as an IP address, PLC programming logic, and a network layout. At operation 1040, PLC analyzer 200 determines supported bus types, based on the COMM card configured on the PLC. At operation 1045, PLC analyzer 200 generates and sends messages to scan devices behind the PLC, based on the supported bus types determined at operation 1040, in order to find nested PLCs. Operations 1025-1045 are performed for each project file. At operation 1050, PLC analyzer 200 audits devices found in networks and buses; i.e., the actual current network layout. Operations 1025-1050 constitute the active collection phase of method 1000.

At operation 1055, PLC analyzer 200 compares the actual current network layout determined at operation 1050, with information extracted from the project files at operation 1020. At operation 1060, PLC analyzer 200 detects misconfigurations in the project files, based on the comparison performed at operation 1055. At operation 1065, PLC analyzer 200 suggests corrections to the project files, and makes recommendations regarding what to add to the PLC configuration and/or the PLC logic to improve the automation process. The recommendations may be based on the results of the comparison. For example, if the active collection phase detects certain cards and devices that are not configured in the PLC configuration, then the recommendation may be to modify the network layout and hardware configured in the PLC configuration file accordingly. Operations 1055-1065 constitute the comparison and detection phase of method 1000.

It will be appreciated that embodiments of the present invention apply to DCSs in addition to PLC networks, and that the description above refers to a PLC network only for the sake of clarity.

It will be appreciated by those skilled in the art that the present invention offers many advantages over conventional tools for detecting misconfigurations. The present invention provides an engineer with a “second” look at PLC configurations, to validate and eliminate configuration errors before the errors cause any damage. Following the “second” look the engineer will be able to trust the network and its configurations.

The present invention enables the engineer to automatically detect misconfigurations, without the need to manually review each PLC and compare a configuration to an actual network layout.

The present invention enables the engineer to review previous and current PLC configurations. As such, the engine may easily investigate what has been changed over the years.

The present invention provides the engineer with important statistics, including inter alia how frequently a configuration is changed, how many misconfigurations were found in a specific time span, and how many PLCs share similar configuration attributes, such as internal IP addresses.

The present invention enables the engineer to define security policies and receive reports of which devices and configurations deviate from the desired policy. E.g., the customer may define a policy that disallows dynamic host configuration protocol (DHCP) for PLCs, and allows only static IP addresses. Embodiments of the present invention scan configurations and generate a report of which devices are configured to use a dynamic IP address.

In the foregoing specification, the invention has been described with reference to specific exemplary embodiments thereof. It will, however, be evident that various modifications and changes may be made to the specific exemplary embodiments without departing from the broader spirit and scope of the invention. Accordingly, the specification and drawings are to be regarded in an illustrative rather than a restrictive sense.

What is claimed is:

1. A method for detecting misconfigured industrial automation devices within an operational technology (OT) network of programmable logic controllers (PLCs), each PLC comprising one or more central processing unit (CPU) cards, one or more communication cards, and one or more input/out (I/O) cards, each I/O card controlling a machine or process in a physical network, the method comprising:
parsing a project file that comprises information about a PLC and its configuration, and about the logic that runs on the PLC;
generating a network layout configured in the project file, based on the results of said parsing;
scanning the PLC comprising extracting information regarding the PLC configuration and the network layout;
generating an actual network layout, based on the results of said scanning; and
comparing the actual network layout with the network layout configured in the project file, to detect misconfigurations in the project file.

2. The method of claim 1 wherein said parsing comprises assigning a parser to the project file, based on file type of the project file.

3. The method of claim 2 wherein the assigned parser extracts information about the types of cards in the PLC, a network identity of the PLC, and a network layout configured in the PLC.

4. The method of claim 1 wherein said scanning comprises:
generating an information request packet, in an appropriate industrial control system (ICS) protocol, for the PLC; and
transmitting the information request packet to the PLC.

5. The method of claim 4 where the PLC, in response to receiving the information request packet, provides information about a PLC type, cards configured on the PLC, a network identity of the PLC, and program logic currently being executed on the PLC.

6. The method of claim 5 wherein said scanning comprises inferring bus types supported by the PLC, based on a communication card configured on the PLC.

7. The method of claim 1 wherein said scanning comprises discovering one or more other PLCs communicatively coupled with the PLC via one or more respective communication cards configured on the PLC.

8. The method of claim 1, further comprising generating suggestions as to what to correct in the project file and/or in the physical layout, based on said comparing.

9. The method of claim 1 further comprising generating recommendations regarding additions to the PLC configuration or the PLC logic, for improving an automation process.

10. The method of claim 1 further comprising generating an historical report of PLC configuration changes.

11. The method of claim 1 further comprising generating a statistical report comprising one or more of (i) how frequently the PLC configuration is changed, (ii) the number of misconfigurations found in a specific period of time, and (iii) how many PLCs have similar attributes.

12. The method of claim 1 further comprising generating a security report comprising which devices and configurations violate a desired security policy.

13. The method of claim 1 further comprising generating recommendations regarding additions to the PLC configuration or the PLC logic, for improving network security controls.
